(19) United States
(12) Patent Application Publication
(10) Pub. No.: US 2012/0112608 A1
(43) Pub. Date: May 10, 2012

(54) ELECTRIC MACHINE HAVING AN INTEGRATED INVERTER

(75) Inventors: Bradley D. Chamberlin, Pendleton, IN (US); Alex Creviston, Muncie, IN (US)

(73) Assignee: REMY TECHNOLOGIES, L.L.C., Pendleton, IN (US)

(21) Appl. No.: 12/939,359

(22) Filed: Nov. 4, 2010

(51) Int. Cl. H02K 5/22

(52) U.S. Cl. 310/68 D

(57) ABSTRACT

An electric machine system includes an alternating current (AC) electric machine. The AC electric machine includes a machine housing having a machine portion and a switch portion. A stator is fixedly mounted in the machine portion, a rotor rotatably mounted relative to the stator, and a plurality of switch members are arranged within the switch portion. The plurality of switch members are electrically connected to the stator. A direct current power source is electrically connected to the plurality of switch members. A controller is arranged within a controller housing and electrically connected to the plurality of switch members. The controller housing is distinct from and remotely mounted relative to the AC electric machine. The controller is configured and disposed to activate select ones of the plurality of switch member to convert DC current between the DC power source and an AC current to operate the AC electric machine.

### BACKGROUND OF THE INVENTION

Exemplary embodiments pertain to the art of electric machines and, more particularly, to an electric machine having an integrated inverter.

Conventional electric motor systems, such as those used in automotive, agricultural, and other heavy duty applications where electric and hybrid motors are employed, include an electric motor operatively coupled to an inverter through high voltage cabling. A typical inverter includes a controller portion and a multi-phase power switching portion. The multi-phase power switching portion includes various high voltage components such as insulated gate bipolar transistors (IGBTs), metal oxide semiconductor field effect transistors (mosfets), rectifiers, capacitors, inductors, high voltage wiring and the like. The inverter is electrically connected to an engine control module, a high voltage battery, and the electric motor. The connections between the inverter and the battery, and the inverter and the electric motor, require high voltage cabling. In addition, the heat generated by operation of the high voltage components requires cooling. As such, conventional inverters are also typically connected to a cooling system. Cooling systems for inverters include a fluid coolant such as oil, water, air or other media that can absorb and retain heat.

### BRIEF DESCRIPTION OF THE INVENTION

Disclosed is an electric machine system including an alternating current (AC) electric machine. The AC electric machine includes a machine housing having a machine portion and a switch portion. A stator is fixedly mounted in the machine portion of the machine housing, a rotor rotatably mounted relative to the stator, and a plurality of switch members are arranged within the switch portion of the machine housing. The plurality of switch members are electrically connected to the stator. A direct current power source that includes a direct current is electrically connected to the plurality of switch members. A controller is arranged within a controller housing and electrically connected to the plurality of switch members. The controller housing is distinct from and remotely mounted relative to the AC electric machine. The controller is configured and disposed to selectively activate select ones of the plurality of switch member to convert the DC current between the DC power source and an AC current to operate the AC electric machine.

Also disclosed is an alternating current (AC) electric machine. The AC electric machine includes a machine housing having a machine portion and an switch portion, a stator fixedly mounted in the machine portion of the machine housing, a rotor rotatably mounted relative to the stator, and a plurality of switch members arranged within the switch portion of the machine housing, the plurality of switch members being electrically connected to the stator, the plurality of switch members being configured and disposed to convert direct current to AC current to operate the AC electric machine.

### BRIEF DESCRIPTION OF THE DRAWINGS

The following descriptions should not be considered limiting in any way. With reference to the accompanying drawings, like elements are numbered alike:

FIG. 1 depicts an electric machine system in accordance with an exemplary embodiment; and

FIG. 2 depicts an alternating current (AC) electric machine of the electric machine system of FIG. 1.

### DETAILED DESCRIPTION OF THE INVENTION

A detailed description of one or more embodiments of the disclosed apparatus and method are presented herein by way of exemplification and not limitation with reference to the Figures.

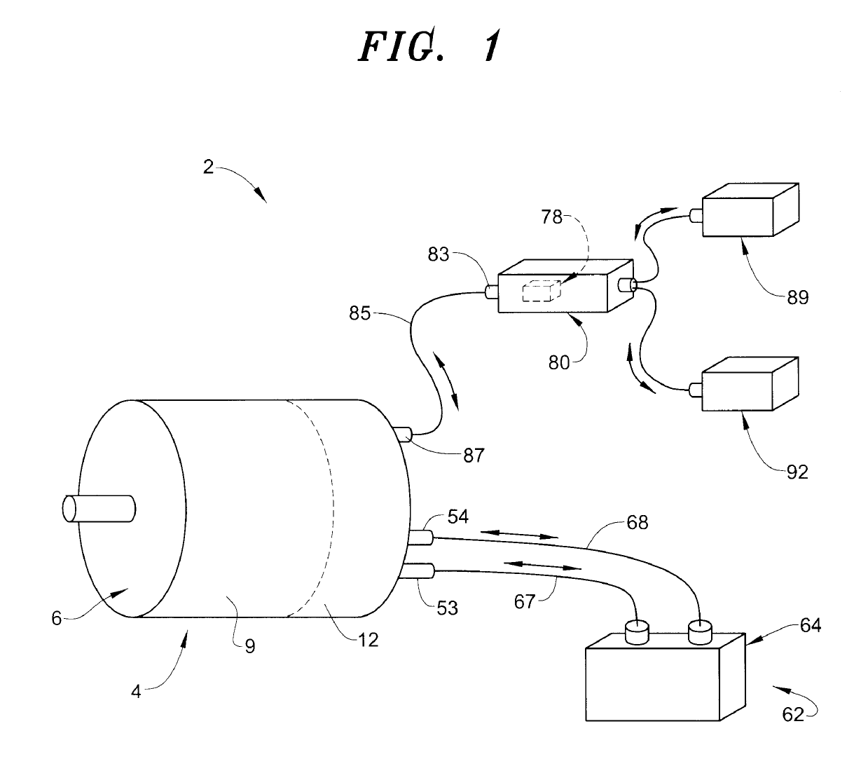

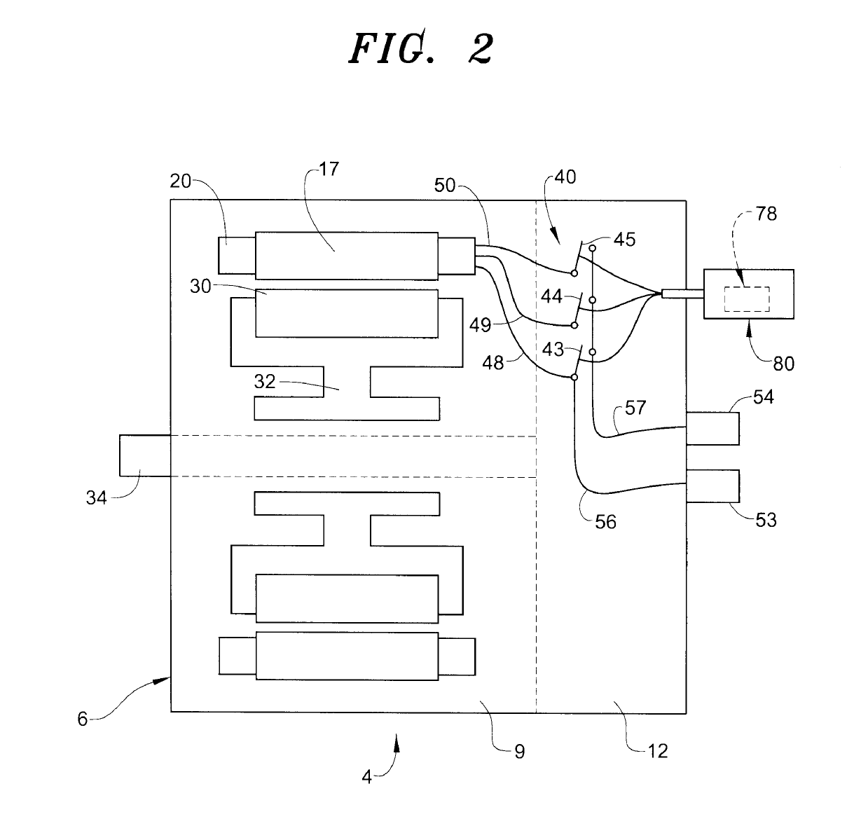

With reference to FIGS. 1 and 2, an electric machine system constructed in accordance with an exemplary embodiment is indicated generally at 2. Electric machine system 2 includes an alternating current (AC) electric machine shown in the form of an electric motor 4 having a machine housing 6. Machine housing 6 includes a machine portion 9 and a switch portion 12. In the exemplary embodiment shown, machine portion 9 includes a stator assembly 17 having a plurality of windings 20. Windings 20 define a number of phases for AC electric motor 4. More specifically, AC electric motor 4 constitutes a multi-phase electric motor. Machine portion 9 is also shown to include a rotor assembly 30 having a rotor hub 32 that is operatively coupled to an output shaft 34. At this point, it should be understood that the electric machine in accordance with the exemplary embodiment could take the form of an electric motor, i.e., an electric machine provided with an electric current input to produce a mechanical output or an electric generator, i.e., an electric machine provided with a mechanical input that is transformed into an electrical current.

In accordance with an exemplary embodiment, switch portion 12 of machine housing 6 includes a plurality of inverter switch members 40 that are electrically connected to stator assembly 17. Inverter switch members 40 include a first switch member 43 that is electrically connected to a first phase winding (not separately labeled) of stator assembly 17 by a first high voltage conductor 48, a second switch member 44 that is electrically connected to a second phase winding (not separately labeled) of stator assembly 17 by a second high voltage conductor 49, and a third switch member 45 that is electrically connected to a third phase winding (not separately labeled) of stator assembly 17 by a third high voltage electric conductor 50. Switch members 40 take the form of insulated gate bipolar transistors (IGBTs), metal oxide semiconductor field effect transistors (mosfets), rectifiers, capacitors, inductors and the like. At this point it should be understood that while only three switch members are shown, the number, location and type of switch members can vary. “High voltage” should be understood to mean any voltage shared between electric AC motor 4 and a power supply. In accordance with one exemplary aspect, “high voltage” is voltage in a range of between about 100 volts to about 1000 volts and above. Voltage should be understood to include voltage supplied by inverter switch members 40 to the electric machine when operated in a motor mode or passed to inverter switch members 40 when the electric machine is operated in a generator mode. In general, voltage should be understood to include energy that is exchanged between the electric machine and inverter assembly 40 resulting in a transformation of energy between a mechanical and electrical state. Inverter switch members 40 are electrically connected to first and second power terminals 53 and 54 provided on machine housing 6. Power terminals 53 and 54 are electrically connected to inverter switch members 40 by first and second high voltage conductors 56 and 57. In accordance with the exemplary embodiment, conductors 48-50 and 56-57 are arranged within machine housing 6. Power terminals 53 and 54 are also electrically connected to a direct current (DC) power source, shown in the form of a high voltage battery 64, by high voltage cables 67 and 68. Thus, in the exemplary embodiment shown, AC electric motor 4 is provided power by DC power source 62.

Electric machine system 2 is shown to include a controller 78 that is electrically connected to inverter switch members 40. Controller 78 electrically activates (opens/closes) inverter switch members 40 to transform DC electrical current from DC power source 62 to a multi-phase AC electric current that is used to power AC electric motor 4. Controller 78 is arranged within a controller housing 80 that is remote from AC electric motor 4. Controller housing 80 includes a control terminal 83 that electrically connects controller 78 to AC electric motor 4. More specifically, controller 78 is linked to switch members 40 by a low voltage cable 85 that extends between control terminal 83 and a control terminal element 87 provided on machine housing 6. The term “low voltage” should be understood to mean voltage shared between controller 78 and switch portion 12 employed to achieve a change in state, e.g., open/close, inverter switch members 40. In accordance with one aspect of the exemplary embodiment, “low voltage” constitutes voltage in a range of between greater than about 0 volts and about 99 volts. Electric machine system 2 is also includes a motor control module 89 electrically connected to controller 78. Motor control module 89 establishes a desired operational speed for AC electric motor 4. Controller 78 is also shown linked to additional control inputs 92 such as accessory control modules, or other vehicle operational parameter modules such as torque, speed, power control and the like.

At this point it should be understood, that by incorporating inverter switches into the machine housing, there is no need for additional high voltage cables to run between the controller and the electric motor. Moreover, cooling requirements for the inverter switches can be satisfied by coolant used to cool machine portions, e.g., stator, and rotor, of the electric machine. In this manner, the inverter can be divided into separate switch and control portions that are mounted remotely from one another.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. An electric machine system comprising:
an alternating current (AC) electric machine including a machine housing having a machine portion and a switch portion, a stator fixedly mounted in the machine portion of the machine housing, a rotor rotatably mounted relative to the stator, and a plurality of switch members arranged within the switch portion of the machine housing, the plurality of switch members being electrically connected to the stator;
a direct current (DC) power source including a direct current is electrically connected to the plurality of switch members; and
a controller arranged within a controller housing and electrically connected to the plurality of switch members, the controller housing being distinct from and remotely mounted relative to the AC electric machine, the controller being configured and disposed to selectively activate select ones of the plurality of switches to convert the DC current between the DC power source and an AC current to operate the AC electric machine.

2. The electric machine system according to claim 1, wherein the AC electric machine is a multi-phase electric motor.

3. The electric machine system according to claim 2, wherein the plurality of switch members includes a first switch member that establishes a first phase of the multi-phase electric motor, a second switch member that establishes a second phase of the multi-phase electric motor, and a third switch member that establishes a third phase of the multi-phase electric motor.

4. The electric machine system according to claim 2, wherein no more than two high voltage cables electrically connect the AC electric machine with the DC power source.

5. The electric machine system according to claim 2, wherein the controller is electrically connected to the plurality of switch members through a low voltage electric cable.

6. The electric machine system according to claim 1, wherein the DC power source is a battery.

7. The electric machine system according to claim 6, wherein the battery is a high voltage battery having a voltage rating above 100 volts.

8. The electric machine system according to claim 1, further comprising: a motor control module electrically connected to the controller.

9. The electric machine system according to claim 1, wherein the controller is operatively coupled to a motor control module.

10. An alternating current (AC) electric machine comprising:
a machine housing having a machine portion and a switch portion;
a stator fixedly mounted in the machine portion of the machine housing;
a rotor rotatably mounted relative to the stator; and
a plurality of inverter switch members arranged within the switch portion of the machine housing, the plurality of inverter switch members being electrically connected to the stator, the plurality of switch members being configured and disposed to convert direct current to AC current to operate the AC electric machine.

11. The AC electric machine according to claim 10, further comprising: a controller arranged within a controller housing and electrically connected to the plurality of switch members, the controller housing being distinct from and remotely mounted relative to the AC electric machine, the controller being configured and disposed to selectively activate select ones of the plurality of switches to convert DC current to AC current to operate the AC electric machine.

12. The AC electric machine according to claim 11, further comprising: a motor control module electrically connected to the controller.

13. The AC electric machine according to claim 11, wherein the controller is operatively coupled to a motor control module.

14. The AC electric machine according to claim 10, wherein the AC electric machine is a multi-phase electric motor.

15. The AC electric machine according to claim 14, wherein the plurality of switch members includes a first switch member that establishes a first phase of the multi-phase electric motor, a second switch member that establishes a second phase of the multi-phase electric motor, and a third switch member that establishes a third phase of the multi-phase electric motor.

16. The AC electric machine according to claim 14, wherein no more than two high voltage cables are electrically connected to the AC electric machine.

17. The AC electric machine according to claim 14, wherein the controller is electrically connected to the plurality of switch members through a low voltage electric cable.
